(19) United States
(12) Patent Application Publication
(10) Pub. No.: US 2026/0129094 A1
(43) Pub. Date: May 7, 2026

(54) TECHNIQUES FOR MULTI-CLOUD DELEGATION OF COMPLIANCE EVIDENCES FOR SECURE EVIDENCE COLLECTION

(71) Applicant: Anecdotes.ai, LTD, Tel Aviv (IL)

(72) Inventors: Michael KIPNIS, Rishon LeTsiyon (IL); Omri ROSNER, Tel Aviv (IL); Roni ALTSHULER, Tel Aviv (IL); Alon MORGENSTERN, Yavne (IL); Or YAGEL, Herzliya (IL)

(73) Assignee: Anecdotes.ai, LTD, Tel Aviv (IL)

(21) Appl. No.: 18/937,804

(22) Filed: Nov. 5, 2024

(51) Int. Cl. H04L 67/1097; H04L 9/40; H04L 67/02

(52) U.S. Cl. CPC H04L 67/1097; H04L 63/10; H04L 67/02

(57) ABSTRACT

A system and method for multi-cloud delegation of compliance evidence data is presented. The method includes querying a user system using a fetched application programming interface (API) key; determining that the fetched API key matches an API key of the user system, wherein the API key of the user system is unique to the user system; collecting raw evidence data from the user system, upon determining that the fetched API key matches the API key of the user system; establishing connections with a plurality of datastores via an abstract layer, wherein the plurality of datastores is deployed at multiple cloud platforms; and storing the collected raw evidence data at the plurality of datastores over the established connections.

### TECHNICAL FIELD

The present disclosure relates generally to security compliance, particularly for managing compliance evidences in multiple cloud environments.

### BACKGROUND

Government, Risk, and Compliance (GRC) strategy is adopted and integrated in many organizations, big and small, in order to achieve organization objectives. Here, compliance indicates the organization's compliance with requirements of internal and/or external guidelines, also referred to as frameworks. Frameworks are widely accepted guidelines or standards that are established by external organizations for individuals, organizations, or the like to adhere to, in order to protect data that are handled and utilized. Common frameworks include, for example, but not limited to, Security and Compliance Standard (SOC), Health Insurance Portability and Accountability Act (HIPAA), Payment Card Industry Data Security Standard (PCI DSS), and the like. Stakeholders may leverage such frameworks to gauge the validity and/or security of the organization. Incompliance with frameworks can lead to adverse effects such as financial penalties, loss of operating licenses, investigations, and more.

Thus, compliance with present and future processes, as well as activities to address such compliance requirements may be key features for the maintenance and healthy growth of the organization. Organizations can implement compliance programs that include tools, strategies, and the like, to ensure compliance at different stages and with frameworks. Based on their business sector, the organization may be more concerned with one framework over another. In many cases, organizations may be concerned about the organization's compliance with one or more frameworks.

It has been identified that evidences may be collected from all parts of the organization to determine compliance. Evidences are data or documents such as, but not limited to, policies, manuals, standard operation procedures, regulatory mandates, training records, and the like, and more that suggest a compliance state (or posture) of the organization.

Currently implemented techniques often rely on manual pulling of evidences, which are limited to isolated auditing and checking off of boxes in a list of audit requirements. The technique is manually performed at a specific time of need (e.g., before an audit, at reporting season, and the like). The static nature of the current techniques does not capture the ever-changing, exponential growth of the organization within and in relation to third-party entities. That is, compliance analyses and postures determined using currently implemented techniques may be limited in scope and out of date to provide inaccurate analyses of the organization's compliance.

In order to provide accurate and encompassing analyses of compliance, evidences may be pulled from different portions of the organization's infrastructure, which may operate in one or more cloud environments, a local server or hardware, and the like, and any combination thereof. However, handling communications and data within such a variety of infrastructures that may have different configurations as well as compatibilities can be complex and challenging to implement. And further, exposing the organization's infrastructures and sensitive evidence data faces potential risks of privacy and security breaching.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for multi-cloud delegation of compliance evidence data. The method comprises: querying a user system using a fetched application programming interface (API) key; determining that the fetched API key matches an API key of the user system, wherein the API key of the user system is unique to the user system; collecting raw evidence data from the user system, upon determining that the fetched API key matches the API key of the user system; establishing connections with a plurality of datastores via an abstract layer, wherein the plurality of datastores is deployed at multiple cloud platforms; and storing the collected raw evidence data at the plurality of datastores over the established connections.

Certain embodiments disclosed herein also include a non-transitory computer readable medium having stored thereon causing a processing circuitry to execute a process, the process comprising: querying a user system using a fetched application programming interface (API) key; determining that the fetched API key matches an API key of the user system, wherein the API key of the user system is unique to the user system; collecting raw evidence data from the user system, upon determining that the fetched API key matches the API key of the user system; establishing connections with a plurality of datastores via an abstract layer, wherein the plurality of datastores is deployed at multiple cloud platforms; and storing the collected raw evidence data at the plurality of datastores over the established connections.

Certain embodiments disclosed herein also include a system for multi-cloud delegation of compliance evidence data. The system comprises: a processing circuitry; and a memory, the memory containing instructions that, when executed by the processing circuitry, configure the system to: query a user system using a fetched application programming interface (API) key; determine that the fetched API key matches an API key of the user system, wherein the API key of the user system is unique to the user system; collect raw evidence data from the user system, upon determining that the fetched API key matches the API key of the user system; establish connections with a plurality of datastores via an abstract layer, wherein the plurality of datastores is deployed at multiple cloud platforms; and store the collected raw evidence data at the plurality of datastores over the established connections.

Certain embodiments disclosed herein include the method, non-transitory computer readable medium, or system noted above or below, further including or being configured to perform the following step or steps: discarding runtime data, wherein the runtime data includes the raw evidence data.

Certain embodiments disclosed herein include the method, non-transitory computer readable medium, or system noted above or below, further including or being configured to perform the following step or steps: initiating an evidence collection to collect the raw evidence data from the user system; and fetching the API key from a key datastore, wherein the key datastore is identified by the abstract layer.

Certain embodiments disclosed herein include the method, non-transitory computer readable medium, or system noted above or below, further including or being configured to perform the following step or steps: identifying the plurality of datastores and credentials based on user policies and metadata; fetching the credentials for each the plurality of datastores; and querying the plurality of datastores using the fetched credentials.

Certain embodiments disclosed herein include the method, non-transitory computer readable medium, or system noted above or below, wherein the user policies and the API key are defined by a user entity associated with the user system.

Certain embodiments disclosed herein include the method, non-transitory computer readable medium, or system noted above or below, wherein the initiating is performed according to a predetermined schedule.

Certain embodiments disclosed herein include the method, non-transitory computer readable medium, or system noted above or below, wherein collecting the raw evidence data is performed separately per at least one of: system, account, and user entity.

Certain embodiments disclosed herein include the method, non-transitory computer readable medium, or system noted above or below, wherein the raw evidence data are associated with metadata, wherein the metadata is at least one of: a user entity identifier (ID), an instance ID, a user system ID, an account ID, a collection time, and a compliance test result.

Certain embodiments disclosed herein include the method, non-transitory computer readable medium, or system noted above or below, further including or being configured to perform the following step or steps: retrieving the raw evidence data from a first datastore of the plurality of datastores upon matching the fetched credential to a credential of the first datastore; processing the raw evidence data as processed evidence data and to determine a compliance state to at least one framework; storing the processed evidence data in the first datastore; and discarding raw evidence data and the processed evidence data.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flowchart illustrating a method for collecting and delegating evidence data according to an embodiment.

FIG. 3 is a flowchart illustrating a method for retrieving evidence data according to an embodiment.

FIG. 4 is a schematic diagram of a collector system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for secure multi-cloud delegation of compliance evidences of an organization and its sub-systems. The embodiments herein disclose the efficient collection and storage of compliance evidence data by employing an abstract layer that manages communication to multiple components parallelly. The raw data of evidences are securely collected, communicated, and stored at a plurality of datastores distributed in various cloud computing platforms. More particularly, the communications with each of the multiple components including, without limitation, a user system, an integrated user system, datastores, and the like are authorized and authenticated by their unique credentials. It should be noted that the embodiments herein provide added security in the data communications and data storage at the various components, which is advantageous for any type of data but also important for compliance-related evidence data that includes security sensitive information of the organization.

The embodiments disclosed herein enable parallel writing to multiple storage spaces to reduce writing time and memory at the evidence system. The abstract layer employs a plurality of user policies and metadata to efficiently determine designated storage locations, their credentials, and the like for the compliance evidences to perform the multi-cloud delegation. The plurality of user policies is defined by the user entity of the organization and may be readily modified. The abstract layer, disclosed herein, is configured to seamlessly incorporate the plurality of user policies for any modifications or updates without further configurations. It should be noted that the replicated storage of compliance data at multiple clouds improves data availability and resilience as well as recovery in times of fail out. Moreover, the storage itself as well as replicated storage eliminates repeated connection and collection from the user systems, thereby reducing security risks and conserving computing resources.

Moreover, the embodiments disclosed herein provide user (i.e., user entity of the organization) control over the compliance evidences and communications thereof. The plurality of user policies, set by the user entity, define, without limitation, the credentials, storage location of credentials, designated datastores of compliance evidences, and the like and more. In addition, the various components such as, but not limited to, the plurality of datastores distributed in multiple cloud computing platforms, user systems, and the like, are deployed at the user side to permit access and connection through strict authentication and authorizations. In an embodiment, the credentials are confirmed for any connection, for reading or writing, to the user-side components, and the credential values themselves are governed by the user. To this end, the compliance evidence data are securely managed by the user entity to restrict undesired connections to other systems including, for example, previously recognized systems. Furthermore, the compliance evidences and runtime data associated with the collection are removed from the collecting evidence system, thereby securing the compliance evidences at the user side.

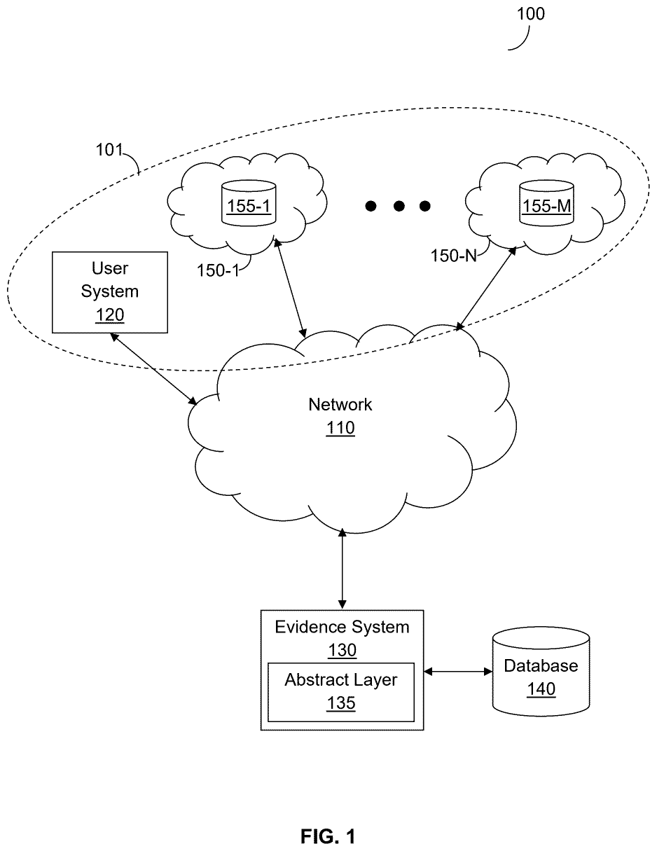

FIG. 1 shows an example network diagram 100 utilized to describe the various disclosed embodiments. In the example network diagram 100, a user system 120, an evidence system 130, a database 140, and a plurality of cloud environments 150-1 through 150-N (hereinafter referred to individually as a cloud 150 and collectively as clouds 150, merely for simplicity purposes, and wherein N is an integer greater than 1) communicate via a network 110. The network 110 may be, but is not limited to, a wireless, cellular or wired network, a local area network (LAN), a wide area network (WAN), a metro area network (MAN), the Internet, the world wide web (WWW), similar networks, and any combination thereof. In an embodiment, the database 140 may be directly connected to the evidence system 130. In another embodiment, the database 140 may be deployed in the same cloud computing platform as the evidence system 130.

The plurality of clouds 150 are cloud computing platforms having resources that are utilized by a user entity (or owner) of the user system 120. The clouds 150 are configured with at least one datastore 155-1 through 155-M (hereinafter referred to individually as a datastore 155 and collectively as datastores 155, merely for simplicity purposes and wherein M is an integer greater than 1) that are communicatively connected over the network 110 to the various components.

The cloud 150 including at least one datastore 155 may be, but is not limited to, a public cloud, a private cloud, or a hybrid cloud and may be cloud computing platforms of, for example, but not limited to, Amazon® Web Services (AWS), Cisco® Metacloud, Microsoft® Azure®, Google® Cloud Platform (GCP), and the like. In an embodiment, the clouds 150 are of the same platform, different platforms, or both. That is, different combinations of cloud computing platforms are communicatively connected to the various components of FIG. 1 over the network. In an example embodiment, the one or more clouds 150 may be running on the same cloud computing platform, but at different geographical locations.

The datastores 155 may be, for example, but not limited to, an application programming interface (API) datastore, an evidence datastore, and the like, and any combination thereof, to store an API key, raw data of evidence, normalized data of evidence, and the like, and any combination thereof. The API keys are defined as credentials or identifiers to authenticate and authorize access to, for example, and without limitations, the user system 120, its integrated plugins (e.g., services, application, etc.), and the like, over an application programming interface (API). The evidence data (e.g., raw evidence data, normalized evidence data, etc.) are evidences of compliance that are collected and/or processed at the evidence system 130 and subsequently stored at the datastores 155. The evidences are data and/or documents that are relevant to framework compliance and include, for example, but not limited to, policies, standard operation procedures, audit trails and logs, training records, incident response plans, change management policies, risk assessment, third-party agreements, user system 120 (or plugin) configuration, and the like, and any combination thereof of the user system 120 and/or its integrated plugins.

In an embodiment, the operations to read from and/or write to the datastores 155 may be controlled by an authentication and authorization process. To this end, queries to the datastores 155 are accompanied by credentials for each of the datastores 155 to allow access upon receiving the correct credentials. In an embodiment, the credentials for accessing the datastores 155 may be stored at the database 140 that is associated with the evidence system 130.

In an embodiment, the clouds 150 and datastores 155 thereof are associated with the user entity of the user system 120 in a user side 101. To this end, the user entity manages the configurations, locations, access, credentials, and the like, of the clouds 150 and the datastores 155. In an example embodiment, the credentials to access the datastores 155 may be modified by the user entity to limit other entities (e.g., evidence system 130, external entities, suspicious entities, etc.) accessing the datastores 155 for API keys or evidence data. In another example embodiment, the API keys stored at the datastores 155 are modified to prevent communication and access into the user system 120, integrated user systems 120 (i.e., the plugins of the user system), and the like. One of ordinary skill in the art would understand that such control over the clouds, datastores, credentials, and the like, provide added protection at the user system 120 and any data that may be stored in the datastores 155.

A single datastore 155 is depicted in each cloud 150 in FIG. 1 as an illustration, however, it does not limit the scope of the disclosed embodiments. The cloud 150 may include one or more datastores for the entity of the user system 120. As an example, a cloud includes two datastores, one for the API keys and another for evidence data (e.g., raw data and normalized data). In another example, a cloud includes one datastore 155 storing the API keys for access into the integrated user system 120. In yet another example, a cloud includes one datastore for the API keys and two evidence datastore for evidence data originating from different plugins (e.g., applications) integrated in the user system 120.

The user system 120 may be a component, a server, a system, a device, an infrastructure, or the like. The user system 120 may be deployed with one or more plugins (e.g., service, application, etc.), which are referred to as integrations. The plugin may be a software component that operates to provide, for example, but not limited to, cloud infrastructure, development tools, organizational tools, identity providers, human resource tools, security tools, and the like, and more. The plugin may be accessed via an Application Programming Interface (API). Each plugin in the user system 120 includes a plurality of evidences of compliance (or simply referred to as evidences herein) as raw data that may be collected and utilized for compliance analyses for the entity of the user system 120 as a whole and/or with respect to the respective plugin. The term user system may be used herein to refer to the user system 120 as a whole, as well as the plugins deployed at the user system 120.

The user system 120 is configured to be accessed via the API for the collection of the plurality of evidences for compliance. The access permissions to the user system 120 are authenticated by the API key set by the user entity. Thus, the user system 120 is protected from undesired connections, for example, from potentially malicious entities. As noted above, the API key is managed by the user entity with respect to value, storage, location, and the like, to enable user control over user system 120. In an embodiment, the API key is stored and may be retrieved from the datastore 155 with the correct matching credentials to the respective datastore 155. In another embodiment, the API key is stored at the evidence system 130 side, for example, at the database 140.

It should be noted that although one user system 120 is depicted in FIG. 1, merely for the sake of simplicity, the embodiments disclosed herein may be applied to a plurality of user systems that are associated with a same entity, different entities, or both. The user system 120 may be deployed in a cloud environment such as a private cloud, a public cloud, or a hybrid cloud. The evidence system 130 is configured to communicate with the plurality of user systems 120 as separate instances, for example, per user entity, per system, per account, and the like.

According to the disclosed embodiments, the user system 120, the clouds 150, and the datastores 155 are deployed at the user side (indicated as dashed circle 101) of the communication and are controlled by the user entity regarding their infrastructure, configuration, permissions, backup, storage, and the like, and more. It should be noted that such components may be deployed on the same, different, or both types of cloud environments and providers with flexibility. It should be further noted that the communication between the user system 120 and the datastores 155 is performed through the evidence system 130.

The evidence system 130 is a component, a server, a device, a system, or the like configured to communicate evidence data and determine compliance of the user system 120. The evidence system 130 collects raw data of evidence from the user system 120 for further compliance analyses. In addition, the evidence system 130 connects to designated datastores 155 in the plurality of clouds 150 to securely communicate the evidence data (e.g., raw, normalized, analyzed, etc.), which may be stored, retrieved, and utilized. In an embodiment, the connections to the user system 120 and the datastores 155 are established through querying using specific credentials (e.g., API key, credentials for designated datastores, etc.), which are authenticated and authorized for communication.

In an embodiment, the collection of evidences, to query and collect, may be initiated according to a predetermined schedule. In a further embodiment, the collection of evidence may be initiated on demand. The query, including API keys, for access to at least one plugin at the user system 120 is submitted via the API. The access may be permitted in the presence of a correct API key of the user system 120 at the queried time. The API key is unique for the user system 120, the plugin of the user system 120, and the like. In an embodiment, the API keys are delegated to the datastores 155 at the user side 101 and are retrieved therefrom prior to the collection. In another embodiment, the API keys are stored at the database 140 associated with the evidence system 130.

In an embodiment, the evidences of compliance are collected from the user system 120 as raw data per user entity (e.g., per customer), per system, and per account. The user entity may have one or more accounts that are connected and monitored by the evidence system 130 for evidence collection. Thus, the collected raw data are separately collected and stored without shared memory and/or resources. The evidence system 130 may include a server instance with a static Internet Protocol (IP) address, which may run for each collection session. Upon completing collection at each collection session, the connection may be terminated. In an embodiment, runtime data relevant to the collection session such as, but not limited to, fetched credentials, the connection configuration and details, the API key, and the like, may be discarded when the session ends. The collection session may be defined, for example, as a predetermined time window.

The evidences may be data and/or documents that are relevant to framework compliance and include, for example, but not limited to, policies, standard operation procedures, audit trails and logs, training records, incident response plans, change management policies, risk assessment, third-party agreements, user system 120 (or plugin) configuration, and the like, and any combination thereof. The raw data of evidences collected for the user system 120 may be associated with metadata such as, but not limited to, user name or identifier (ID), instance ID, user system ID, collection time, compliance test result (e.g., success or failure), and the like and stored in the database 140. It should be noted that the metadata does not include privacy or security sensitive information with respect to the user entity.

According to the disclosed embodiments, an abstract layer 135 is deployed at the evidence system 130 to manage communication and evidence data with respect to the plurality of datastores 155. The abstract layer 135 may be realized as at least one code stored, for example, in a memory (not shown) in the evidence system 130 and executed to communicate with the remote clouds 150 and their datastores 155. It should be noted that the at least one code is realized without modification in communicating with the one or more clouds 150 and datastores 155. In some implementations, the abstract layer 135 may be stored in a memory in a cloud environment of the evidence system 130. The abstract layer 135 is configured to establish a secure connection with the plurality of clouds 150 and manage writing and/or reading of data such as, but not limited to, API keys, raw evidence data, normalized evidence data, and the like, and any combination thereof. For an instance, the abstract layer 135 determines locations of data, necessary credentials, storage location, and the like, establishes connections, retrieves correct credentials and/or evidence data, stores at determined storage locations, and the like. The storage location may be local (e.g., the database 140), remote (e.g., the datastores 155), or both.

The abstract layer 135 is executed to determine, for example, but not limited to, designated datastores 155, network configurations, credentials, and the like and any combination thereof, based on a plurality of user policies for the user entity. As an example, the abstract layer 135 is executed upon completing the collection session to determine the designated datastore for the collected evidence data, establish the secure connection to the designated datastore according to the respective cloud configuration, fetch credentials for the respective datastore, and store the evidence data into the respective datastore. In another example, the abstract layer 135 is executed to query raw evidence data stored at the datastores at the plurality of clouds. That is, the abstract layer 135 identifies the datastores including specific raw evidence data, establishes a connection, and retrieves using appropriate credentials and network configurations. It should be noted that the abstract layer 135 governs various connections from the evidence system 130 such as, but not limited to, the evidence datastores, API key datastores, the user system 120, and the like, and any combination thereof.

The plurality of user policies may be defined by the user entity regarding, for example, but not limited to, types of data, designated storage locations for each data type, and the like, and any combination thereof. For example, the plurality of user policies for a first user entity (e.g., customer) indicates that all evidence data is to be stored in a single GCP project. In another example, the plurality of user policies for a second user entity may indicate portions of the raw data to be stored in a first datastore and the other portion of the raw data in a second datastore on the GCP platform; and further indicate that credentials are to be stored in the AWS platform. The abstract layer 135 is configured to determine the cloud 150 and/or datastores 155 to connect to, employ the appropriate software development kit (SDK), and establish a secure connection all based on the user policies.

In an embodiment, the abstract layer 135 is configured to integrate with a plurality of clouds 150 of different cloud platforms in parallel, simultaneously. Any new clouds 150 are introduced to the abstract layer 135 for seamless integration of the new clouds and associated resources with the evidence system 130. It should be noted that the abstract layer 135 enables seamless integrations by managing the connections to the plurality of clouds without adding complexity to the evidence system 130. To this end, modification of the whole system and/or instructions is eliminated to reduce complexity and burden on the computational resources. It should be further noted that processing time to write, read, and analyze evidence data is also reduced through the parallel writing and/or reading of evidence data enabled by the abstract layer.

According to the disclosed embodiments, runtime data including, for example, but not limited to, credentials, API key, evidence data, and the like, that may include sensitive information are discarded from the evidence system 130 to ensure security protection at the user side 101. Although the evidence data 130 is configured to communicate with at least the user system 120 and the datastores 155, such communication is permissible only to the extent that the user entity associated with the user system 120 allows it. As noted above, the user system 120, the datastores 155, and the clouds 150, are deployed and controlled at the user side 101 to be controlled and managed by the user entity. To this end, unwanted connections to the user system 120 and any user side 101 resources are effectively restricted to reduce potential security risks. It should be noted that a plurality of user systems may communicate with the evidence system 130 using a secure manner to collect evidence data. Each user entity and/or user system may have datastores at the plurality of clouds.

The evidences may be data and/or documents that are relevant to framework compliance and include, for example, but not limited to, policies, standard operation procedures, audit trails and logs, training records, incident response plans, change management policies, risk assessment, third-party agreements, user system 120 (or plugin) configuration, and the like, and any combination thereof. The raw data of evidences are analyzed by applying the rules of a framework in order to determine a compliance state of the plugin with respect to the framework. The framework is a set of predetermined guidelines including regulations, standards, rules, auditing procedures, and the like, and any combination thereof for information security that are widely adopted by individuals, organizations, vendors, or the like. It has been identified that compliance with such frameworks is an essential factor for the operation of an organization. Some examples of established frameworks include, without limitations, Security and Compliance Standard (SOC), Health Insurance Portability and Accountability Act (HIPAA), International Organization for Standards (ISO) 27001, and the like, and more. As an example, a success/failure of an evidence with respect to the rules of the SOC framework may be determined. The raw data of evidences collected for the tenant may be associated with metadata such as, but not limited to, user name or identifier (ID), instance ID, user system ID, collection time, test result (e.g., success or failure), and the like and stored in the database 140 or other databases (not shown).

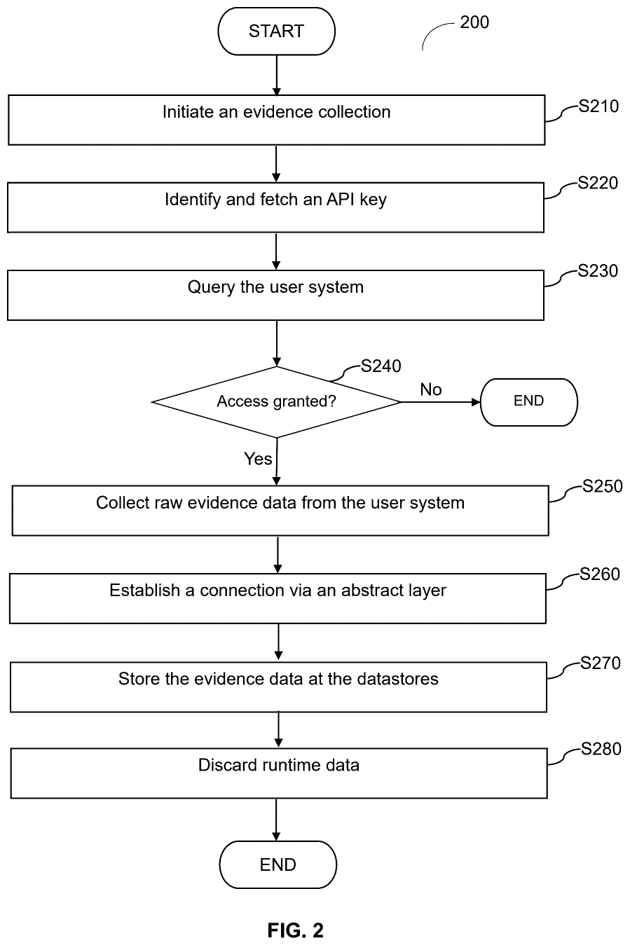

FIG. 2 is an example flowchart 200 illustrating a method for collecting and storing raw data of evidences of compliance according to an embodiment. The method described herein is performed in the evidence system 130, FIG. 1.

The raw data is collected from the user system 120 and stored at datastores 155 of a plurality of clouds 150 communicating over the network. It should be noted that the collection and storage of raw data of evidence may be performed per user, per integrated system (e.g., the user system 120, a plugin of the user system 120), and per account, thereby avoiding shared memory or resources. The term user system, herein, refers to the user system 120, a plugin of the user system 120, and the like.

At S210, an evidence collection is initiated. The evidences of compliance are collected from at least one plugin at the user system (i.e., the integrated user system), which is accessed by querying with a unique API key for the at least one plugin. The access for evidence collection is granted upon authentication of the unique API key. The evidence collection initiation is a start of a collection session. In an embodiment, the evidence collection is initiated via a dedicated runtime.

The initiation may be performed according to a predetermined schedule, for example, weekly, every 3 days, or the like. The predetermined schedule may be defined for each user entity to initiate collection from all integrated user systems of the user. In another example embodiment, the predetermined schedule may be defined for a subset of user systems (or plugins) of the user entity. In some implementations, the collection may be initiated on demand by a user associated with the user system (e.g., the user system 120, FIG. 1). The authorized personnel may request initiation via an API gateway (not shown) with authentication, which initiates the collection based on the request. The initiation request may include details on one or more user systems to be specifically called for evidence collection.

At S220, an API key for evidence collection is identified and fetched. The API key is a credential for authorized connection with the integrated user system 120 and may be stored and fetched from, for example, at least one datastore in the cloud (e.g., the datastore 155, FIG. 1), a memory, a database of the evidence system (e.g., the database 140, FIG. 1), and any combination thereof. The correct API key and storage location of the initiated evidence collection is identified based on a plurality of user policies and metadata (e.g., account ID, user system ID, and the like). It should be noted that the API key value and the storage location are set and managed by the user entity, which are provided and utilized by the abstract layer of the evidence system (e.g., the abstract layer 135 of the evidence system 130, FIG. 1). In some embodiments, the correct API key to collect evidences according to the initiation is stored locally, and thus, fetched from the local database (e.g., the database 140, FIG. 1).

In some embodiments, the API keys are stored in one or more datastores on at least one cloud environment (e.g., the datastores 155 of the clouds 150, FIG. 1). The database (e.g., the database 140, FIG. 1) is looked up to identify the storage location of the API key which may be one or more datastores at one or more cloud computing platforms such as, but not limited to, Amazon® Web Services (AWS), Cisco® Metacloud, Microsoft® Azure®, Google® Cloud Platform (GCP), and the like, and any combination thereof. The datastore having the API key is queried using a datastore-specific credential and configurations for the respective datastore, which is retrieved from the memory and/or database of the evidence system. It should be noted that the datastore-specific credential and API keys may be defined by a user (or owner) of the user system to modify the API key storage location and actual values. To this end, access and blocking of the connection to the datastore having the API key is controlled by the user of the user system. In an embodiment, the fetched API keys and the credentials are stored in a temporary memory at the evidence system.

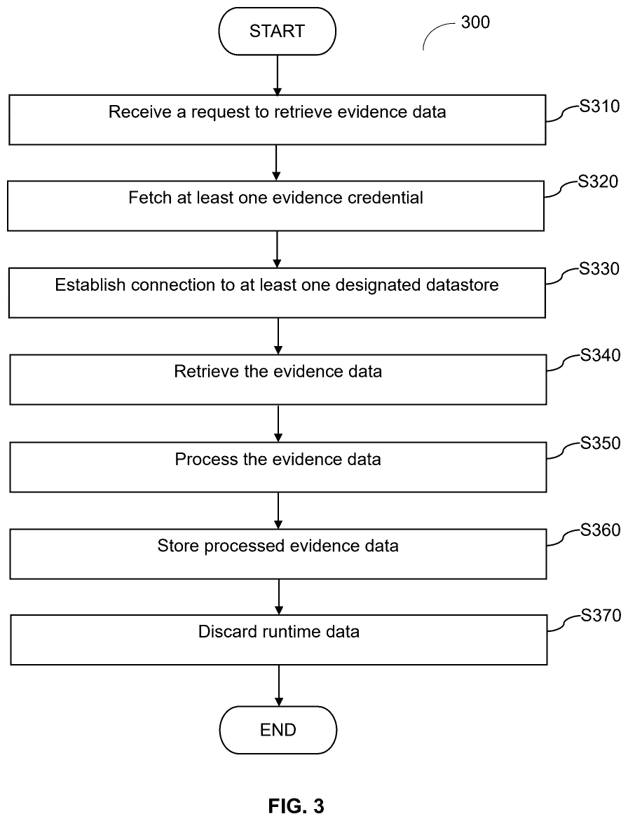

The datastores having the API key are accessed via an abstract layer of the evidence system (e.g., the abstract layer 135, FIG. 1). The abstract layer is triggered to connect and fetch the API key from the datastores identified to store the API key. However, it should be noted that the at least one datastore having the API key may not be accessed, no connection and no retrieval, without a user-approved datastore-specific credential. The abstract layer is a piece of code deployed and executed at the evidence system that manages access, to read and/or write from, and network communication with the plurality of cloud environments and its resources, such as the datastores. The communication with the datastores located at multiple clouds via the abstract layer of the evidence system is described further in FIG. 3 with respect to the retrieval of the evidence data stored at datastores of such configurations. It should be noted that the retrieval process of FIG. 3 is described using the evidence data for illustrative purposes and does not limit the scope of the present disclosure. The process of retrieval may be performed for retrieval of the API keys, or other data, from the datastores at the plurality of cloud environments.

At S230, the user system is queried with the retrieved API key. The API key is the unique API key that is specific to the queried user system and retrieved upon initiation of the evidence collection as described in S210 and S220. In an embodiment, the API key may be for a plugin of the user system such as, but not limited to, a service, an application, or the like. In another embodiment, the API key may be for the user system.

At S240, it is checked whether access to the user system is granted. If so, operation continues with S240; otherwise, the operation ends. The access to the user system is granted upon querying with the correct or up-to-date API key.

The API key is set and updated by the user entity of the user system to have control over connections. In an example embodiment, the queried API key may not match the up-to-date API key of the user system when the user entity has changed the API key, and thus, access is not granted. In such a scenario, an evidence system that previously had access to the user system may no longer have access to the same user system. It should be noted that such control at the user system and the authentication provides a security layer to block undesired connections to the user system. In some embodiments, a schedule or time window for access to the user system may be predefined. In such a scenario, the access to the user system may not be granted to queries outside the predefined schedule or time window, even with the correct API key. As an example, the predefined schedule allows access and evidence data collection only on the weekends. The predefined schedule or time window may be part of the plurality of user entities.

At S250, raw data of evidence is collected from the accessed user system. In an embodiment, the raw data of evidence may be collected from the integrated user system of at least one plugin. The raw data of evidence includes data related to compliance with various frameworks. In an example embodiment, the raw data does not include a compliance state to a specific framework but rather data that relates to compliance guidelines and may be utilized to determine compliance states for various frameworks through the analyses at the evidence system.

The raw data may be collected from the evidence such as, but not limited to, policies, standard operation procedures, audit trails and logs, training records, incident response plans, change management policies, risk assessment, third-party agreements, user system configuration, and the like, and any combination thereof, that may be pulled from the accessed user system. As noted, the evidence may be data and/or documents that are relevant to and may indicate compliance with one or more framework guidelines. In an embodiment, the collection of evidence data is performed as separate instances for each user, each user system, and each account, thereby preventing the sharing of memory or resources between them. It should be noted that such segregation enables the secure collection of evidence data from various plugins, user systems, accounts, cloud platforms, user entities, and the like.

In an embodiment, the raw evidence data is stored in the temporary memory at the evidence system. In a further embodiment, the access to the user system is terminated upon completing the collection of raw data of evidence. The decision to stop collection and stop access (i.e., end the collection session) may be determined by, for example, a predetermined time period for collection, a lower threshold transmission rate, a threshold transmission volume, or the like. In some implementations, the access to the user system may be maintained even after completing the collection of the raw data.

In some embodiments, the raw data of evidence gathered during the collection session may be processed, for example, as normalized data of evidence, and utilized to determine compliance states with respect to at least one framework, or the like. The normalized data of evidence represents the raw data in a format of fields, tables, or the like that is predefined by the evidence system. The normalized data facilitates extraction and understanding of the evidence data, thereby improving the efficiency of the compliance analyses. The normalized data of evidence may be further processed by applying rules of the at least one framework to determine the respective compliance state of the user entity and may be associated with metadata. The metadata includes, for example, but not limited to, tenant name or identifier (ID), instance ID, user system ID, collection time, test result (e.g., success or failure), and the like, and may be stored at the temporary memory and/or the database (e.g., the database 140, FIG. 1). The details of processing the raw data of evidence are described in FIG. 3, S350 herein below. In an embodiment, the processed data may also be stored at the temporary memory with the associated raw evidence data.

At S260, connections to a plurality of clouds and designated datastores in the plurality of clouds are established via an abstract layer (e.g., the abstract layer 135). The abstract layer is called and executed to determine the network configuration, designated datastores, and datastore credentials based on a plurality of user entity policies. That is, the storage location (e.g., designated datastore, designated cloud platform, etc.) for the collected data, credentials to access the storage location, storage location of the credentials, and the like are determined by the abstract layer. In an embodiment, the abstract layer is a piece of code that is deployed and executed at the evidence system to manage communication between the evidence system and the datastores at the plurality of clouds. The abstract layer is configured to determine and seamlessly establish a secure connection with the designated datastores.

It should be noted that the abstract layer identifies and connects to other components (e.g., the datastores, the user systems, etc.) according to the plurality of user policies, which is governed and controlled by the user entity. In an example embodiment, the user policies may define designated storage locations of collected evidence data to be different cloud environments. As an example, the designated datastores may differ based on the type of evidence data or source plugin from which the evidence data is collected. The human resources (HR) type of evidence data may be stored in a single GCP account for secure monitoring and other evidences may be redundantly stored in multiple clouds of different cloud providers (e.g., GCP, AWS, and more),

In an embodiment, credentials for the designated datastores are retrieved from the memory and/or the database (e.g., the database 140, FIG. 1) associated with the evidence system. The credentials are authenticated by the datastores in order to establish the secure connection. The datastores are deployed at different cloud platforms (or cloud services) that have different network configurations. It should be noted that the datastores are managed by the user entity of the user system, but do not directly communicate with the user system for communicating evidence data (e.g., raw, normalized, processed, etc.).

At S270, the evidence data is stored at the designated datastores at the plurality of clouds. In an embodiment, the evidence data (e.g., raw, normalized, processed, and the like) are stored at multiple datastores simultaneously over the established connections. In some implementations, the evidence data is stored with respect to a unique identifier. It should be noted that the parallel writing via the abstract layer allows fast communication and storage at the multiple datastores designated by the user entity. It should be further noted that the multi-cloud connection and writing ensure safe storage of evidence data in at least one datastore. In an embodiment, the evidence data are separately and securely stored, for example, per integration, per account, per user entity, and the like.

It should be noted that the raw data collected from a single evidence collection session may be used to determine compliance states for more than one framework. That is, repeated evidence collection is avoided, thereby reducing computing resources in memory and power.

At S280, the runtime data is discarded. The runtime data includes, for example, but is not limited to, connection credentials for the datastores, the API key, logs, evidence data (e.g., raw, normalized, processed, etc.), and the like, and any combination. Such runtime data may include information about the user entity and the particular collection session. In an embodiment, the runtime data that are stored at the temporary memory are purged upon termination of collection and storage. In an example embodiment, a server instance for the evidence collection may be terminated. To this end, the evidence system does not contain sensitive information with respect to the user system. A fresh connection and collection of evidence data is enabled.

In an embodiment, the evidence system, in the memory and/or database, may include metadata associated with the collected or processed evidence data. Such metadata does not provide meaningful information with respect to the user system, its integrated systems, its datastores, or the evidence data.

It should be noted that such clean-up of session-related data (particularly indicating a connection to the user system) ensures a secure connection and access to the user system, the datastores, or both. It should be further noted that the network configurations at the abstract layer are preserved for efficient and seamless connections upon initiation.

According to the disclosed embodiments, the process of collecting and storing the collected evidence data at multiple datastores is performed for each initiation of evidence collection. The raw evidence data collected from a single evidence collection session may be used to determine compliance states for more than one framework at different times. That is, repeated evidence collection is avoided, thereby reducing computing resources of memory and processing power. In an embodiment, the process may be run in a dedicated server instance in the evidence system. The process is described with respect to a single component of the plugin, user system, user entity, and the like for simplicity. It should be noted that the process may be performed simultaneously for a plurality of such components without departing from the scope of the present disclosure.

It should be noted that the process described herein to store evidence data in multiple clouds does not limit the scope of the disclosed embodiments. The method described herein may be applied to any data that is to be securely stored at one or more datastores deployed at multiple cloud environments. In an example embodiment, the delegation of the API keys to access various user systems (or each plugin) may be stored in remote datastores at the user side (e.g., the datastores 155 at the user side 101) according to the methods described herein. As noted above, the abstract layer of the evidence system (e.g., the abstract layer 135 and the evidence system 130, FIG. 1) is executed to determine the storage location, credentials for the storage location, retrieve credentials, establish a connection, communicate the API key, and store at the determined storage location. As an example, such storage of credentials may be conducted during the initial set-up between the evidence system and the user system. It should be noted that the runtime data determined and collected during the process is discarded to ensure security of the API key, datastore, and the like that are employed during the process.

FIG. 3 is an example flowchart 300 illustrating a method for retrieving evidence data according to an embodiment. The method described herein is performed at the evidence system 130, via the abstract layer 135, FIG. 1. The evidence data is retrieved from the datastores 155 at a plurality of cloud environments 150, FIG. 1. In an embodiment, the evidence data are retrieved to determine a compliance of an integrated user system, a user system, or a user entity as a whole that is related to the retrieved evidence data.

At S310, a request to retrieve evidence data is received. The request includes at least one metadata to define a type of evidence data to be retrieved. For example, the request includes a user ID, an instance ID, and a collection time to initiate retrieval of evidence data that matches the request values. In an embodiment, the request may be received, for example, at a predetermined schedule, on demand, and the like, and any combination thereof. As an example, the retrieval of evidence data is performed monthly at a preset date and time to generate a monthly compliance report. As another example, on demand retrieval is performed when auditing is due. In yet another example, the evidence data are retrieved to store the evidence data at another datastore, for example, to transfer the evidence data, as a replicate, both, or more.

At S320, at least one evidence credential is fetched from the database based on the request for evidence data. The at least one credential is a unique information or identifier that is authenticated for access to at least one designated datastore. In an embodiment, fetching is performed via the abstract layer to retrieve credentials for the at least one designated datastore storing the requested evidence data. In a further embodiment, the abstract layer fetches the at least one evidence credential based on a plurality of policies for the user entity. Here, the abstract layer identifies the storage location storing the requested evidence data and the at least one evidence credential needed to access the storage location. In an example embodiment, the plurality of policies may include, for example, rules, weights, rankings, and the like, that are utilized to determine the credentials to fetch. In some configurations, the same evidence data is redundantly stored at multiple datastores. The plurality of policies may be utilized to identify one of the multiple datastores to retrieve the evidence data.

In an example embodiment, the one datastore to retrieve evidence data is selected according to a priority list of datastores, cloud environment, or both. In such a scenario, a first datastore at the top of the priority list may be selected to fetch the evidence data from. Thus, evidence credential for the specific first datastore is fetched. It should be noted that the priority list may also be utilized to determine alternative datastores that carry the replication of the requested evidence data. Such alternative datastores are utilized for evidence data retrieval upon failure to access and/or retrieve requested data from the first designated datastore.

The database (e.g., the database 140, FIG. 1) is associated with the evidence system and stores credentials for the datastores (e.g., the datastores 155, FIG. 1), which stores evidence data (e.g., raw, normalized, etc.) that are previously collected from the user system (e.g., the user system 120, FIG. 1), API keys, and the like. It should be noted that values of the at least one evidence credential are determined and updated by the user entity of the user system, thereby giving the user entity control over accessing such datastores.

At S330, a connection to at least one designated datastore is established via the abstract layer (e.g., the abstract layer 135). As noted above, in particular S250, FIG. 1, the abstract layer identifies user configuration, network configuration, datastores, credentials for the datastores, cloud environment, and the like, to establish a secure connection with at least one datastore in the cloud.

At S340, the evidence data is retrieved from the at least one designated datastore. The at least one designated datastore is queried using the fetched evidence credential. The retrieved evidence credential is matched to that of the designated datastore. Upon matching, the evidence system is given access to the designated datastore to retrieve the requested evidence data. The evidence data stored at the designated datastore includes, for example, the raw data, the normalized data, the processed data, and the like, relevant to the request, which are stored in a temporary memory at the evidence system (e.g., the evidence system 130, FIG. 1). In an example embodiment, the designated datastore is not accessible upon determining a mismatch between the fetched credential and that of the designated datastore being queried. It should be noted that such matching of credentials ensures restricted and controlled access into the datastore to reduce breaching of privacy and security. It should be further noted that the privacy and security of such datastores are important for the compliance-related evidence data.

According to the disclosed embodiments, the retrieved evidence data are portions of the stored evidence data in the designated datastore according to the request. As an example, the request may include values for metadata such as a user system ID and a range of collection times in order to retrieve relevant evidence data rather than all data that are stored at the designated datastore. It should be noted that a subset of evidence data may be selectively retrieved.

In an example embodiment, querying the designated datastore may not result in the retrieval of the stored evidence data. In another example embodiment, the datastore may not be accessible and the retrieval of stored evidence data may not occur. For example, the connection to and/or the designated datastore itself may have failed. In another example, the evidence credentials for the designated datastore may not match. In such a scenario, the abstract layer of the evidence system may be triggered to query and to retrieve stored evidence data from an alternative datastore, in any cloud environment, based on the user policy. The query to the alternative datastore would again include a specific credential that is unique to the alternative datastore. The alternative datastore is another designated datastore that stores a duplicate of the requested evidence data. It should be appreciated that such redundant storage at multiple datastores, particularly at different cloud environments, reduces potential loss of data and disruptions in evidence collection, and further, the compliance analysis processes. As an example, when access to the first designated datastore fails, a second alternative datastore is selected from a priority list of the user policy. The connection to the second alternative datastore is established through the similar process described above of the designated datastore (e.g., S320 through S340).

In some implementations, the evidence data related to an integrated user system, a user system, or a user entity are simultaneously collected from multiple designated datastores. Such simultaneously collected evidence data include same data, different data, or both. As an example, the requested evidence data may be stored at two different designated datastores of different cloud platforms. Such evidence data is simultaneously collected and processed, together or separately, to provide compliance insights for the user system. It should be noted that the retrieval of evidence data is based on the plurality of policies of the user and thus, contamination of evidence data between users is prevented.

At S350, the retrieved evidence data is processed. The evidence data for the user system are processed to determine compliance of, for example, the user system, the plugins of the user system, the user entity, and the like. In an embodiment, the compliance state (or compliance posture) is determined with respect to one or more frameworks. The compliance state (or test result) includes, for example, but is not limited to, ready for audit, approved, gap, and the like, and any combination thereof. In another example embodiment, the compliance state may be a score or percentage of compliance against the rules or policies for a respective framework. It should be noted that the evidence data may be processed to determine compliance states to more than one framework. Thus, repeated evidence retrieval is avoided to conserve computing resources in memory and power. In an embodiment, the evidence data retrieved from multiple datastores may be processed together which may provide a comprehensive compliance analysis of the user system and/or user entity.

In an embodiment, the metadata for the evidence data may be updated based on the processed result. For example, the compliance state for a new framework may be added. In another example, the compliance state for a framework is updated to “fail” according to the changes in the framework guidelines.

In an embodiment, the retrieved evidence data is converted to normalized data of evidence. The normalized data is formatted into predefined fields and utilized in compliance analyses to reduce processing costs and time. In some implementations, the normalized data may be stored back into the respective datastore from which the raw data was retrieved. In other implementations, the normalized data may be stored at a different datastore, in the same or different cloud from that of the respective raw data's datastore.

The evidence data may be data and/or documents that are relevant to framework compliance and include, for example, but not limited to, policies, standard operation procedures, audit trails and logs, training records, incident response plans, change management policies, risk assessment, third-party agreements, user system 120 (or plugin) configuration, and the like, and any combination thereof. The evidence data (e.g., raw or normalized data of evidences) are analyzed by applying rules of a framework in order to determine a compliance state of the plugin with respect to the framework.

The framework is a set of predetermined guidelines including regulations, standards, rules, auditing procedures, and the like, and any combination thereof for information security that are widely adopted by individuals, organizations, vendors, or the like. It has been identified that compliance with such frameworks is an essential factor for the operation of an organization. Some examples of established frameworks include, without limitations, the Security and Compliance Standard (SOC), the Health Insurance Portability and Accountability Act (HIPAA), the International Organization for Standards (ISO) 27001, and the like, and more. As an example, a success/failure of an evidence with respect to the rules of the SOC framework may be determined.

At S360, the processed evidence data is stored at the designated datastore. In an embodiment, the designated datastore is where the evidence data is retrieved from at S320 (i.e., designated datastore for the raw data of evidence). In such a scenario, the secure connection established between the designated datastore and the evidence system is kept alive until the processed evidence data is securely stored. In another embodiment, the processed evidence data is stored at an alternative datastore that is different from the designated datastore. In such a scenario, a connection to the alternative datastore is established using a specific credential as described in S330. The connection established with the designated datastore of the raw evidence data may be terminated before establishing the new connection with the alternative datastore. The alternative datastore may be one or more datastores in any cloud environment.

At S370, the runtime data is discarded. The runtime data including, for example, but not limited to credentials, evidence data (e.g., raw, normalized, processed, etc.), and the like, are purged from the temporary memory. To this end, the evidence system is free from evidence-related and user system-related data upon completing storage of data at the designated datastores at the plurality of clouds.

It should be noted that the datastores are located and managed at the user-side and thus, unknown leakage of evidence and user-related data at the evidence system is prevented. It should be further noted that the memory space of the evidence system is restored, thereby conserving computing resources of memory and computing power.

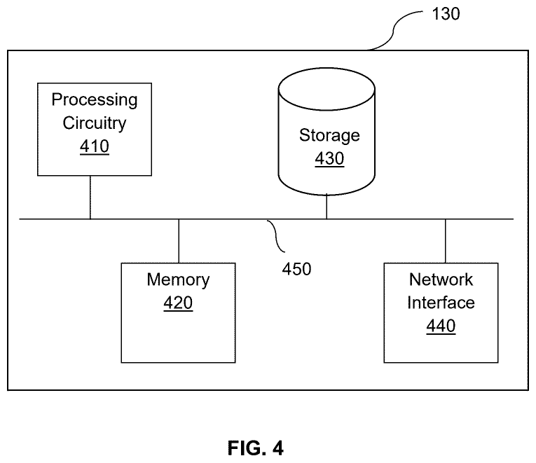

FIG. 4 is an example schematic diagram of an evidence system 130 according to an embodiment. The evidence system 130 includes a processing circuitry 410 coupled to a memory 420, a storage 430, and a network interface 440. In an embodiment, the components of the evidence system 130 may be communicatively connected via a bus 450.

The processing circuitry 410 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 420 may be volatile (e.g., random access memory, etc.), non-volatile (e.g., read only memory, flash memory, etc.), or a combination thereof.

In one configuration, software for implementing one or more embodiments disclosed herein may be stored in the storage 430. In another configuration, the memory 420 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry 410 to perform the various processes described herein.

The storage 430 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 440 allows the evidence system 130 to communicate with other systems, devices, components, applications, or other hardware or software components, for example as described herein.

It should be understood that the embodiments described herein are not limited to the specific architecture illustrated in FIG. 4, and other architectures may be equally used without departing from the scope of the disclosed embodiments.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for multi-cloud delegation of compliance evidence data, comprising:
querying a user system using a fetched application programming interface (API) key;
determining that the fetched API key matches an API key of the user system, wherein the API key of the user system is unique to the user system;
collecting raw evidence data from the user system, upon determining that the fetched API key matches the API key of the user system;
establishing connections with a plurality of datastores via an abstract layer, wherein the plurality of datastores is deployed at multiple cloud platforms; and
storing the collected raw evidence data at the plurality of datastores over the established connections.

2. The method of claim 1, further comprising:
discarding runtime data, wherein the runtime data includes the raw evidence data.

3. The method of claim 1, further comprising:
initiating an evidence collection to collect the raw evidence data from the user system; and
fetching the API key from a key datastore, wherein the key datastore is identified by the abstract layer.

4. The method of claim 1, wherein establishing the connections with the plurality of datastores further comprises:
identifying the plurality of datastores and credentials based on user policies and metadata;
fetching the credentials for each the plurality of datastores; and
querying the plurality of datastores using the fetched credentials.

5. The method of claim 4, wherein the user policies and the API key are defined by a user entity associated with the user system.

6. The method of claim 3, wherein the initiating is performed according to a predetermined schedule.

7. The method of claim 1, wherein collecting the raw evidence data is performed separately per at least one of: system, account, and user entity.

8. The method of claim 1, wherein the raw evidence data are associated with metadata, wherein the metadata is at least one of: a user entity identifier (ID), an instance ID, a user system ID, an account ID, a collection time, and a compliance test result.

9. The method of claim 4, further comprising:
retrieving the raw evidence data from a first datastore of the plurality of datastores upon matching the fetched credential to a credential of the first datastore;
processing the raw evidence data as processed evidence data and to determine a compliance state to at least one framework;
storing the processed evidence data in the first datastore; and
discarding raw evidence data and the processed evidence data.

10. A non-transitory computer readable medium having stored thereon instructions for causing a processing circuitry to execute a process, the process comprising:
querying a user system using a fetched application programming interface (API) key;
determining that the fetched API key matches an API key of the user system, wherein the API key of the user system is unique to the user system;
collecting raw evidence data from the user system, upon determining that the fetched API key matches the API key of the user system;
establishing connections with a plurality of datastores via an abstract layer, wherein the plurality of datastores is deployed at multiple cloud platforms; and
storing the collected raw evidence data at the plurality of datastores over the established connections.

11. A system for multi-cloud delegation of compliance evidences, comprising:
a processing circuitry; and
a memory, the memory containing instructions that, when executed by the processing circuitry, configure the system to:
query a user system using a fetched application programming interface (API) key;
determine that the fetched API key matches an API key of the user system, wherein the API key of the user system is unique to the user system;
collect raw evidence data from the user system, upon determining that the fetched API key matches the API key of the user system;
establish connections with a plurality of datastores via an abstract layer, wherein the plurality of datastores is deployed at multiple cloud platforms; and
store the collected raw evidence data at the plurality of datastores over the established connections.

12. The system of claim 11, wherein the system is further configured to:
discard runtime data, wherein the runtime data includes the raw evidence data.

13. The system of claim 11, wherein the system is further configured to:
initiate an evidence collection to collect the raw evidence data from the user system; and
fetch the API key from a key datastore, wherein the key datastore is identified by the abstract layer.

14. The system of claim 11, wherein the system is further configured to:
identify the plurality of datastores and credentials based on user policies;
fetch the credentials for each the plurality of datastores; and
query the plurality of datastores using the fetched credentials.

15. The system of claim 14, wherein the user policies and the API key are defined by a user entity associated with the user system.

16. The system of claim 13, wherein the initiation is performed according to a predetermined schedule.

17. The system of claim 11, wherein collecting the raw evidence data is performed separately per at least one of: system, account, and user entity.

18. The system of claim 11, wherein the raw evidence data are associated with metadata, wherein the metadata is at least one of: a user entity identifier (ID), an instance ID, a user system ID, an account ID, a collection time, and a compliance test result.

19. The system of claim 14, wherein the system is further configured to:
retrieve the raw evidence data from a first datastore of the plurality of datastores upon matching the fetched credential to a credential of the first datastore;
process the raw evidence data to determine a compliance state to at least one framework;
store the processed evidence data in the first datastore; and
discard raw evidence data and the processed evidence data.
